(19) United States
(12) Patent Application Publication
(10) Pub. No.: US 2025/0131479 A1
(43) Pub. Date: Apr. 24, 2025

(54) Management Method, Server, And Custom Product Management System

(71) Applicant: SEIKO EPSON CORPORATION, Tokyo (JP)

(72) Inventor: Nobutaka SHIOZAKI, Shiojiri-Shi (JP)

(21) Appl. No.: 18/919,514

(22) Filed: Oct. 18, 2024

(30) Foreign Application Priority Data
Oct. 19, 2023 (JP) 2023-180072

(51) Int. Cl. G06Q 30/0601; G06Q 50/04

(52) U.S. Cl. CPC G06Q 30/0621; G06Q 50/04

(57) ABSTRACT

There is provided a management method for a custom product of a vibrator device in a management system including a server and a first terminal device of a customer connected to the server via a network. The server receives, from the first terminal device, custom programming information to be written in the vibrator device. The server generates a custom model number for specifying the received custom programming information.

The present application is based on, and claims priority from JP Application Serial Number 2023-180072, filed Oct. 19, 2023, the disclosure of which is hereby incorporated by reference herein in its entirety.

### BACKGROUND

### 1. Technical Field

The present disclosure relates to a management method, a server, a custom product management system, and the like.

### 2. Related Art

There has been known a method of systemizing order reception to delivery of an oscillator or the like. JP-A-2002-117285 discloses a method of preparing blank oscillators in advance for each of offices of a manufacturer and a server of the manufacturer selecting an office suitable for transfer of an oscillator based on order data received from a terminal of a customer and transmitting data to be written to the blank oscillator to the selected office to realize early delivery of the oscillator.

JP-A-2002-117285 is an example of the related art.

In the method disclosed in JP-A-2002-117285, a customer is required to bear a burden of inputting necessary specifications in detail every time the customer places an order. For that reason, it is desired to construct a system with improved convenience.

### SUMMARY

An aspect of the present disclosure relates to a management method for a custom product of a vibrator device in a management system including: a server; and a first terminal device of a customer connected to the server via a network, the management method including the server: receiving custom programming information to be written in the vibrator device from the first terminal device; and generating a custom model number for specifying the received custom programming information.

Another aspect of the present disclosure relates to a server connected to a first terminal device of a customer via a network, the server including: a receiving unit configured to receive custom programming information to be written in a vibrator device from the first terminal device; and a processing unit configured to, when receiving the custom programming information, generate a custom model number for specifying the custom programming information.

Another aspect of the present disclosure relates to a custom product management system including the above-described server and the first terminal device, in which the first terminal device transmits the custom programming information written in the vibrator device by a writing device to the server.

Another aspect of the present disclosure relates to a custom product management system including: the server, the first terminal device, and a second terminal device connected to the server and the first terminal device via the network, wherein the second terminal device transmits, to the server, the custom model number ordered to the second terminal device by the first terminal device, and the server transmits the custom programming information specified by the received custom model number to the second terminal device.

### BRIEF DESCRIPTION OF THE DRAWINGS

FIG. 1 is a diagram illustrating a configuration example of a management system and the like.

FIG. 2 is a diagram illustrating an example of a flow of processing in an embodiment.

FIG. 3 is a diagram illustrating another configuration example of the management system and the like.

FIG. 4 is a diagram illustrating transmission of custom programming information in more detail.

FIG. 5 is a diagram illustrating another example of the flow of the processing in the embodiment.

FIG. 6 is a diagram illustrating another configuration example of the management system and the like.

FIG. 7 is a diagram illustrating another example of the flow of the processing in the embodiment.

FIG. 8 is a diagram illustrating another example of the flow of the processing in the embodiment.

### DESCRIPTION OF EMBODIMENTS

A preferred embodiment of the present disclosure is explained in detail below. The embodiment explained below does not unduly limit the contents described in the claims. Not all of components explained in the embodiment are essential constituent elements.

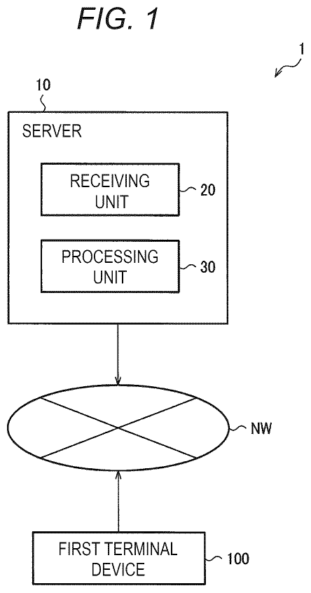

FIG. 1 is a diagram illustrating a configuration example of a custom product management system 1 in the present embodiment. In the following explanation, the custom product management system 1 is sometimes simply referred to as management system 1. The custom product in the present embodiment specifically refers to a custom product of a vibrator device 300. A specific example of the vibrator device 300 is explained below. A custom product of the vibrator device 300 refers to a product, at least a part of specifications of which is configured from the vibrator device 300 that can be customized according to a request of a customer and for which the specifications are decided and work relating to customization is finished. A product configured from the vibrator device 300 is the vibrator device 300 that is formally sold by a manufacturer but may further include the vibrator device 300 that is scheduled to be sold in the near future. That is, in the present embodiment, the vibrator device 300 includes both of the vibrator device 300 that can be customized and the vibrator device 300 that cannot be customized. The vibrator device 300 that can be customized is, for example, the vibrator device 300, an oscillation frequency of an output clock signal output from which is customized according to a request of a customer, and more specifically is a programmable oscillator or the like explained below. In the following explanation, the oscillation frequency is sometimes simply referred to as frequency. As explained below, when the vibrator device 300 includes a central processing unit (CPU), a product obtained by customizing firmware storing instruction set data for the CPU may be a custom product.

In FIG. 1, the management system 1 includes a server 10 and a first terminal device 100. The first terminal device 100 is connected to the server 10 via a The network NW is specifically a public network NW. communication network such as the Internet but may partially include an intranet. The management system 1 illustrated in FIG. 1 is illustrated as including one server 10 and one first terminal device 100 but may include a plurality of servers 10 or may include a plurality of first terminal devices 100. The management system 1 in the present embodiment can include first terminal devices 100 as many as customers explained below.

As explained below, the server 10 is a computer that provides a management service relating to ordering of the custom product of the vibrator device 300 to a customer via the network NW. The server 10 may be a cloud server managed by the manufacturer or may be a physical server owned by the manufacturer. As explained in detail below, the server 10 functions as a Web server. Accordingly, the customer can place an order for the custom product of the vibrator device 300 by, for example, viewing a dedicated Web page concerning a management service on a not-illustrated display unit using a Web browser included in the first terminal device 100 or inputting data on the dedicated Web page. At this time, a client-server network is configured in which the server 10 is a server and the respective first terminal devices 100 are clients. For that reason, for example, data is not transmitted and received between one first terminal device 100 and another first terminal device 100 via the dedicated Web page. The dedicated Web page here may be, for example, a Web page that can be opened by a Web browser serving as dedicated software designated by the manufacturer or a Web page that can be viewed only by a person who receives permission from the manufacturer, although the Web browser is general-purpose software.

The server 10 includes a receiving unit 20 and a processing unit 30. The receiving unit 20 is a communication interface that is communicably connected to an external device via the network NW. The receiving unit 20 can be implemented by an independent semiconductor device having a communication function conforming to a predetermined communication standard but may be implemented as a part of functions of a semiconductor device having other functions. The predetermined communication standard is, for example, a wired communication standard such as Ethernet (registered trademark) or a wireless communication standard such as Wi-Fi (registered trademark) but may be another communication standard. In the present embodiment, “communication connection according to a communication standard” is referred to as “communication connection” or simply as “connection”. Although not illustrated, the server 10 can also function as a transmitting unit by including the communication interface explained above.

The processing unit 30 performs processing of the units of the server 10. The processing unit 30 includes the following hardware. The hardware includes a circuit for processing a digital signal and may further include a circuit for processing an analog signal. For example, the hardware may include one or more circuit devices and one or a plurality of circuit elements mounted on a circuit board. The one or the plurality of circuit devices are, for example, integrated circuits (ICS) and field-programmable gate arrays (FPGAS). The one or the plurality of circuit elements are, for example, resistors or capacitors. The processing unit 30 is implemented by including at least one of processor explained below. The processing unit 30 includes a memory that stores not-illustrated information and a processor that operates based on the information stored in the memory. The information is, for example, programs and various data. The processor includes hardware. As the processor, various processors such as a CPU, a GPU (Graphic Processing Unit), and a DSP (Digital Signal Processor) can be used. The memory may be a semiconductor memory such as a static random access memory (SRAM) or a dynamic random access memory (DRAM), may be a register, may be a magnetic storage device such as a hard disk drive (HDD), or may be an optical storage device such as an optical disk device. For example, the memory stores computer-readable instructions. The processor executes the instructions, whereby a part or all of the functions of the units of the server 10 are implemented as processing. The instructions here may be instructions of an instruction set configuring a program or may be instructions for instructing an operation to a hardware circuit of the processor.

The first terminal device 100 is a terminal device used by a customer, and is, for example, a personal computer. Although not illustrated, the first terminal device 100 includes a processor equivalent to the processing unit 30 explained above and has a function of a processing unit. The Web browser explained above is included in the processing unit. Similarly, the first terminal device 100 includes a communication interface relating to the receiving unit 20 explained above and has a function of a communication unit.

The customer refers to, for example, a person having a record of sales of the vibrator device 300 to the manufacturer or having a record of purchase of the vibrator device 300 from the manufacturer or an organization to which the person belongs but includes a prospective customer or an organization to which the prospective customer belongs. In the following explanation, a “customer or an organization to which the customer belongs” is simply referred to as “customer”. The customer is assumed to be mainly a corporation but may be an individual if there is a possibility of purchasing a predetermined number of vibrator devices 300. The purchase result of the vibrator device 300 includes a record of receiving provision of a service relating to technical support for the vibrator device 300 in addition to a record of receiving provision of sales of the vibrator device 300. The prospective customer refers to, for example, a person who is interested in the vibrator device 300 or the like sold by the manufacturer and is likely to purchase the vibrator device 300 in the near future. For example, in order to incorporate the customizable vibrator device 300 in equipment being developed by the prospective customer and evaluate the vibrator device 300, the prospective customer inquires the manufacturer with predetermined means and asks the manufacturer to provide an evaluation sample of the customizable vibrator device 300. In the following explanation, the evaluation sample of the customizable vibrator device 300 is sometimes simply referred to as “evaluation sample”. The predetermined means is a telephone, a facsimile, an e-mail, or the like but may be inquiry via a Web page. Then, the prospective customer formally orders the custom product of the vibrator device 300 adapted to mass production from the manufacturer based on a result of the evaluation. The ordered custom product of the vibrator device 300 is delivered to the prospective customer via a sales agency explained below. Accordingly, a purchase record is generated. Thereafter, it is possible to order the custom product of the vibrator device 300 via the sales agency.

When a person in charge of a sales department of the manufacturer is attending the customer, the customer can receive quick answers, supports, and the like by communicating a request, a consultation, and the like to the person in charge. However, the person in charge attends only a predetermined customer. The predetermined customer is a so-called major customer, a customer treated as an important customer from a sales source, or the like. The major customer is, for example, a customer, sales of the manufacturer to whom involved in a purchase record occupies a certain proportion or more with respect to an entire sales. The predetermined customer may receive a predetermined support from a sales agency as well. The predetermined support means that, for example, a field application engineer (FAE) belonging to the sales agency performs technical support for a product under development. Accordingly, the manufacturer can establish a closer relationship with the predetermined customer. In the following explanation, among customers, a customer other than the predetermined customer explained above is referred to as “general customer”.

For example, when a product handled by the manufacturer is a vibrator explained below, the manufacturer can assign persons in charge to respective customers because the customers are composed of a small number of major customers. However, when the product handled by the manufacturer is the vibrator device 300, since the vibrator device 300 is widely used by many customers, it is difficult to assign persons in charge of the manufacturer to all general customers. Therefore, when the general customer orders the custom product of the vibrator device 300, a management burden on the general customer increases as customized specifications are more complicated. As explained below, the management system 1 in the present embodiment can reduce the management load on such general customer. This serves as a base for establishing a closer relationship between the manufacturer and the general customer.

Examples of the vibrator device 300 include an oscillator that outputs a clock signal but may include another example. Details are explained below. Although a basic configuration of the oscillator is not illustrated because the basic configuration is publicly known, the oscillator is housed in a package in a state in which a vibrator has high airtightness. Specifically, the vibrator can be implemented by, for example, a surface acoustic wave (SAW) resonator, an AT cut crystal vibration element, an SC-cut crystal vibration element, a tuning fork type crystal vibration element, another piezoelectric vibration element, a micro-electro-mechanical system (MEMS) vibration element, or the like. One end of the vibrator is coupled to a not-illustrated first electrode and the other end is coupled to a not-illustrated second electrode.

The oscillator serving as the vibrator device 300 includes a not-illustrated first vibrator coupling terminal and a not-illustrated second vibrator coupling terminal besides the oscillation circuit. The first vibrator coupling terminal is coupled to the first electrode and the second vibrator coupling terminal is coupled to the second electrode. Accordingly, the oscillation circuit vibrates the vibrator and functions as a circuit for generating a reference clock signal that is an oscillation signal. The oscillator functioning as explained above is, for example, a simple packaged quartz crystal oscillator (SPXO) but may be a voltage-controlled quartz crystal oscillator (VCXO), a temperature-compensated quartz crystal oscillator (TCXO), an oven equipped quartz crystal oscillator (OCXO), a surface acoustic wave (SAW) oscillator, a voltage-controlled SAW oscillator, a micro-electro-mechanical system (MEMS) oscillator, or the like.

Oscillators can be roughly divided into a dedicated vibrator type oscillator in which a frequency of an output clock signal output from a not-illustrated output circuit depends on the shape of a vibrator and a frequency is fixed and a programmable oscillator in which a frequency can be variably set. That is, in the dedicated vibrator type oscillator, the reference clock signal and the output clock signal explained above are the same and cannot be differentiated but, in the programable oscillator, the reference clock signal and the output clock signal explained above can be differentiated. In general, the dedicated vibrator type oscillator is inexpensive and superior in performance compared with the programmable oscillator. For that reason, for example, when a customer considers using the oscillator serving as the vibrator device 300, the customer checks whether a dedicated vibration-type oscillator that oscillates a desired frequency is sold as an existing product. On the other hand, the manufacturer investigates needs of the market and prepares, in terms of sales strategy, a product lineup of a dedicated vibrator type oscillator that outputs a clock signal having a frequency for which needs are high. In the present embodiment, the frequency of the dedicated vibrator type oscillator included in the product lineup is referred to as “standard frequency”. However, the frequency desired by the customer does not always coincide with the standard frequency.

In such a case, for example, the customer may request the manufacturer to add a dedicated vibrator type oscillator that outputs an output clock signal having a new frequency to the existing product lineup. However, unless there is a predetermined reason, the manufacturer is highly likely to not accept the request. The predetermined reason is that, for example, the request is a request from the predetermined customer explained above or a large amount of shipment can be expected. This is because a considerable number of development steps are required until a dedicated vibrator designed anew is made into a product as the vibrator device 300 and, therefore, the manufacturer has to examine a balance with the prospect of a business. For that reason, the general customer sometimes examines the use of a programmable oscillator that can set a desired frequency as the vibrator device 300 that outputs a clock signal having a desired frequency. When delivery with a short delivery time is required, the predetermined customer sometimes examines the programmable oscillator as the customizable vibrator device 300.

In the vibrator device 300 serving as the programmable oscillator, for example, the reference clock signal output from the oscillation circuit explained above is input to a not-illustrated PLL circuit and an output clock signal having a frequency different from the frequency of the reference clock signal is output. Although not illustrated, the PLL circuit includes, for example, a phase comparison circuit, a control voltage generation circuit, a voltage-controlled oscillation circuit, and a frequency division circuit, whereby a function of the PLL circuit is implemented. That is, the phase comparison circuit performs phase comparison between the reference clock signal and a feedback clock signal explained below and outputs a pulse signal having a pulse width proportional to a phase difference to the control voltage generation circuit. The control voltage generation circuit performs a charge pump operation and filter processing based on the input pulse signal, generates a control voltage for controlling the oscillation of the voltage-controlled oscillation circuit, and outputs the control voltage to the voltage controlled oscillation circuit. The voltage-controlled oscillation circuit is a VCO (Voltage controlled oscillator) and includes a variable capacitance element such as a varactor. When the capacitance of the variable capacitance element changes according to the magnitude of the input control voltage, the voltage-controlled oscillation circuit generates, with an oscillation operation, a predetermined clock signal having a frequency corresponding to the control voltage and transmits the predetermined clock signal to the frequency division circuit. The frequency division circuit frequency-divides the received predetermined clock signal based on a set frequency division ratio and outputs the frequency-divided predetermined clock signal to the phase comparison circuit as a feedback clock signal. Thus, a basic operation of the PLL circuit can be implemented. The frequency division ratio is determined by, for example, a frequency division ratio data signal from a not-illustrated processing circuit. The processing circuit includes, for example, a logic circuit but may include, for example, a CPU explained below. The frequency division ratio data signal is provided in, for example, the not-illustrated processing circuit and is determined based on a set value of a register configured by a flip-flop or the like. That is, setting the frequency of the output clock signal of the programmable oscillator to a desired frequency means setting a value of the register to a desired value. As explained below, instead of directly setting the value of the register, the value to be set may be stored in a nonvolatile memory 310. Although detailed explanation is omitted, the PLL circuit is not limited to the configuration explained above and may be, for example, a fractional-N type PLL circuit. In this case as well, setting of the register is required.

Other examples of the vibrator device 300 include a real-time clock device that generates time information using a vibrator and an angular velocity sensor that detects angular velocity using a vibrator. The real-time clock device serving as a custom product is a product in which, for example, the presence or absence of a timestamp function by event detection, voltage setting serving as a reference for power supply voltage detection, assignment of terminals, and the like are programmable. The angular velocity sensor serving as a custom product is a product in which, for example, an angular velocity detection band or a temperature compensation characteristic is programmable. For example, in the vibrator device 300 serving as an angular velocity sensor including a CPU, although not illustrated, a vibrator element is vibrated by a rectangular wave signal or the like from a drive circuit and a detection circuit detects a detection signal generated from the vibrator element as angular velocity data. The CPU performs, based on a temperature correction calculation program, temperature correction calculation for the angular velocity data detected by the detection circuit. In this case, firmware relating to the temperature correction calculation is stored in, for example, the nonvolatile memory 310 explained below. That is, when the vibrator device 300 includes the CPU, the vibrator device 300 of the custom product is the vibrator device 300 capable of customizing the firmware. The same applies to the vibrator device 300 other than the angular speed sensor.

For example, in development of equipment on the customer side, when evaluating an optimum value of the frequency of the output clock signal of the vibrator device 300 incorporated into the equipment, the customer is provided with an evaluation sample and a writing device 110 explained below and sets a desired value in a register of the evaluation sample using the writing device 110. Similarly, when the firmware of the vibrator device 300 to be incorporated into the equipment is customized, the writing device 110 is used to write the firmware in the nonvolatile memory 310 explained below of the evaluation sample.

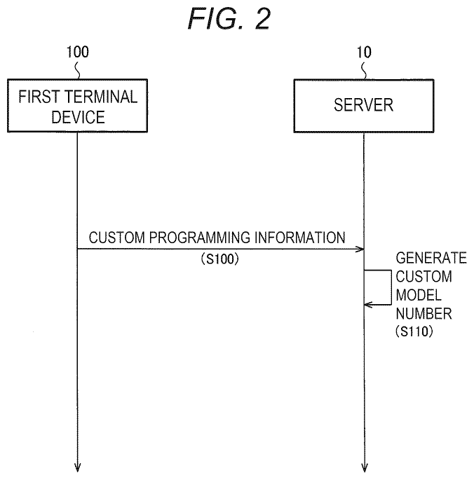

A flow of processing relating to the method in the present embodiment is explained with reference to FIG. 2. The first terminal device 100 transmits custom programming information to the server 10 (step S100). In other words, step S100 can also be considered processing in which the server 10 receives the custom programming information from the first terminal device 100. The custom programming information is programming information relating to customized specifications in the custom product of the vibrator device 300. Details of the custom programming information are explained below. Then, the server 10 generates a custom model number based on the received custom programming information (step S110).

The custom model number is identification information for specifying the custom programming information relating to step S100. That is, the custom model number only has to have a function of specifying the custom programming information and is configured by, for example, a combination of Arabic numerals including a predetermined number of digits. Alternatively, in the custom model number, a combination of an Arabic number and a predetermined character or the like may be configured by a predetermined number of digits. The predetermined character is, for example, an alphabet but may be a Roman number or the like and only has to be a symbol that can be recognized by the server 10 and the first terminal device 100 in common. The predetermined number of digits only has to be larger than the number of times that step S100 is assumed to be performed and is determined as appropriate according to the assumed number of times. More specifically, for example, by configuring the custom model number with five-digit number, 100000 pieces of custom programming information at most can be identified. Alternatively, by configuring the custom model number with a three-digit number or a combination of alphabets, 46656 pieces of custom programming information can be identified. Although in the above number, capital letters and small letters are not distinguished concerning alphabets, the custom model number may include capital letter alphabets and small letter alphabets in a distinguished manner.

Although not illustrated, the server 10 performs processing of correlating the received custom programming information and the created custom model number and storing the custom programming information and the custom model number in a not-illustrated storage unit as a database.

Accordingly, the present embodiment is a method of managing the custom product of the vibrator device 300 in the management system 1 including the server 10 and the first terminal device 100 of the customer connected to the server 10 via the network NW. The server 10 receives custom programming information to be written in the vibrator device 300 from the first terminal device 100 (step S100) and generates a custom model number for specifying the received custom programming information (step S110).

As explained above, in the management system 1 in the present embodiment, the server 10 generates the custom model number such that the custom programming information of the custom product in the vibrator device 300 can be specified. Thus, the server 10 can associate the custom programming information and the custom model number. Accordingly, management of the custom programming information can be facilitated.

For example, when the number of combinations of information necessary for distinguishing the specifications of the custom product of the vibrator device 300 is small, a method of generating a model number by combining characters for identifying the respective pieces of information is conceivable. In the case of the custom product of the vibrator device 300 of the related art, it has been considered that the custom product of the vibrator device 300 can be identified with a model number of approximately ten digits even if all combinations of characters and the like for identifying a model number, a form of a package, a frequency, a use temperature range, and the like are listed. However, program functions of custom products of the vibrator device 300 in recent years are increasing. In particular, in the custom product of the vibrator device 300 including the CPU, the number of combinations of instruction branches is enormous and it is considered that the number of characters of 100 digits or more is required to identify the specifications of the custom product of the vibrator device 300 with the method of the related art. Therefore, it is difficult to identify the specifications of the custom product of the vibrator device 300 only with the model number. In this regard, by applying the method in the present embodiment, the custom programming information can be correlated with the custom model number of several digits. Therefore, the manufacturer can easily manage the custom programming information without complicating the model number notation of the custom product of the vibrator device 300. This can improve the convenience of the management system 1.

For example, for the predetermined customer explained above, even if the specifications of the custom product of the vibrator device 300 are complicated, the management load of the custom programming information can be reduced by receiving the support from the person in charge of the manufacturer or the like explained above. However, the general customer does not always have such convenience. In this regard, since the convenience of the management system 1 is improved by applying the method in the present embodiment, it is possible to reduce the management load of the custom programming information of the general customer. Accordingly, it is possible to construct a closer relationship between the general customer and the manufacturer. Accordingly, for example, since the general customer can easily adopt the vibrator device 300 of the manufacturer, it is possible to increase the possibility that the manufacturer can acquire new business chances. The method relating to the management system 1 in the present embodiment is particularly effective for the general customer. However, the predetermined customer may use the management system 1 in the present embodiment.

The method in the present embodiment may be implemented by the server 10. That is, the server 10 in the present embodiment includes the receiving unit 20 that is connected to the first terminal device 100 of the customer via the network NW and receives the custom programming information to be written in the vibrator device 300 from the first terminal device 100 and the processing unit 30 that, when receiving the custom programming information, generates a custom model number for specifying the custom programming information. Thus, the effects can be obtained as explained above.

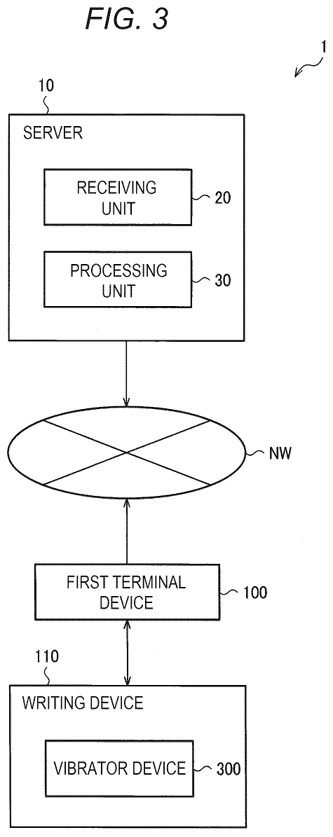

The method in the present embodiment is not limited to the above. Various modifications such as adding other features are possible. For example, more specifically, the management system 1 in the present embodiment can also be configured as in a configuration example illustrated in FIG. 3. In the management system 1 illustrated in FIG. 3, the first terminal device 100 is communicably connected to the writing device 110 by a predetermined communication scheme. The predetermined communication scheme is, for example, a wired connection scheme such as USB.

The writing device 110 is a device that writes the custom programming information in the vibrator device 300. For example, the writing device 110 includes, on a circuit board, an interface for connection to the first terminal device 100 and a socket in which the package of the customizable vibrator device 300 is fitted. That is, the writing device 110 includes an interface circuit connectable to the vibrator device 300. The interface circuit is a circuit that implements an interface such as an inter-integrated circuit (I2C) or a serial peripheral interface (SPI). The interface circuit performs interface processing with the writing device 110 and the like.

For example, when the client examines evaluation of incorporating the customizable vibrator device 300 in equipment under development, the client inquires of the manufacturer and is provided with an evaluation sample and the writing device 110 from the manufacturer. Then, for example, the customer activates a writing program in the first terminal device 100 and writes the custom programming information in the evaluation sample using the writing program. The customer only has to install the writing program in the first terminal device 100 using, for example, a CD-ROM attached to the writing device 110. Alternatively, the customer may download a program relating to the writing program from a Web page designated by the manufacturer. When the first terminal device 100 and the writing device 110 are connected via a USB cable or the like attached to the writing device 110, the writing program may be automatically installed in the first terminal device 100.

For example, although not illustrated, when the customer activates the writing program, a dedicated setting screen is displayed on the display unit of the first terminal device 100. When the customer inputs predetermined setting items on the dedicated setting screen, custom programming information is generated such that contents of the predetermined setting items are reflected in the evaluation sample. For example, when the customizable vibrator device 300 is a programmable oscillator, the predetermined setting items are items relating to characteristics of a clock signal such as an item for inputting a frequency value of an output clock signal, an item for setting a voltage of a clock signal, an item for setting an allowable range of displacement of a frequency, and an item for selecting an output enable function or a standby function. The output enable function refers to a function of setting the output terminal to high impedance while keeping the oscillation circuit and the PLL circuit operating. The standby function refers to a function of stopping the oscillation circuit and the PLL circuit and setting the output terminal to a low level. That is, in the management method in the present embodiment, the custom programming information is information for setting characteristics of a signal output by the vibrator device 300 when the custom programming information is written in the vibrator device 300. Thus, the customer can acquire the vibrator device 300 in which the characteristics of the signal are customized. The predetermined setting items are not limited to the above and may further include an item for selecting a product name, for example, an item for selecting a package type.

The writing program includes a program for automatically calculating the setting value of the register based on the frequency of the reference clock of the evaluation sample and a desired frequency to be set. For that reason, the customer only has to input the desired frequency with a specific number on a predetermined setting screen. Accordingly, the setting value of the register to be set is automatically determined. For example, the customer may be able to directly designate the setting value by designating an address of the register on a screen for describing a predetermined source code.

For example, when the vibrator device 300 includes the CPU, a screen of the writing program may further include a screen for describing the predetermined source code. The predetermined source code is created, for example, in a predetermined programming language. The predetermined programming language may be, for example, an assembly language or a high-level language such as a C language. In this case, a program for converting a created source code into binary data that can be decoded by the CPU only has to be included in the writing program. In this case, the binary data is equivalent to the custom programming information.

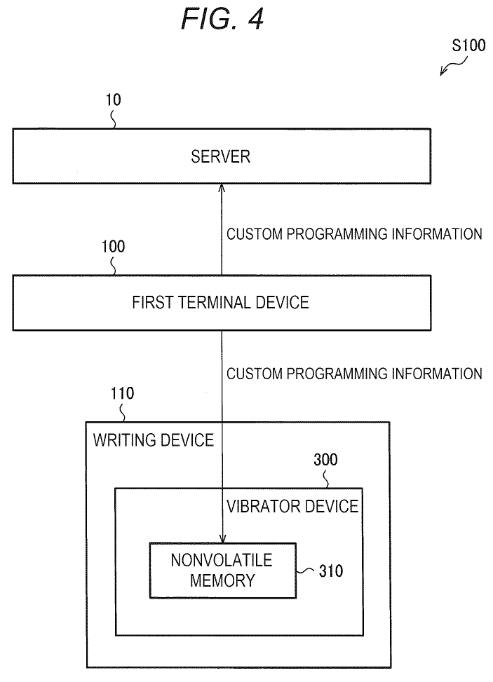

The step S100 is more specifically explained with reference to FIG. 4. When the customer has performed work for writing the custom programming information from the first terminal device 100 in the evaluation sample via the writing device 110, the first terminal device 100 transmits custom programming information relating to the work to the server 10. There are many methods for realizing this processing. For example, there is a method in which the writing program and the Web browser for displaying the dedicated Web page explained above operate in cooperation. That is, when the writing program is activated, the dedicated Web page is automatically opened and step S100 is performed via the dedicated Web page.

For example, when the customer creates custom programming information on the screen of the writing program, the created custom programming information is displayed on the dedicated Web page as well. Then, when the custom programming information is written in the evaluation sample, a screen for requesting agreement to transmission of the created custom programming information to the server 10 via the dedicated Web page is displayed. When the customer agrees, the custom programming information is written in the evaluation sample and the custom programming information is transmitted to the server 10.

That is, in the present embodiment, the writing program installed in the first terminal device 100 is premised to operate when the first terminal device 100 is connected to the server 10 via the network NW. For that reason, it is assumed that, when the customer uses the writing device 110, an agreement to the effect that step S100 is executed by connecting the first terminal device 100 and the server 10 is made between the manufacturer and the customer. It is also assumed that a promise to manage the custom programming information as confidential information is made between the manufacturer and the customer.

These kinds of custom programming information may be generated as, for example, a dedicated file attached with a dedicated extension. In step S100, the dedicated file is transmitted to the server 10 via the dedicated Web page. The dedicated file can also be stored in a not-illustrated storage unit of the first terminal device 100. For example, when the customer or the like activates the writing program at later timing and performs processing for opening the dedicated file on the writing program, the dedicated setting screen on which the predetermined setting items are set and the screen on which the predetermined source code is described are reproduced. In the dedicated file, for example, a file name is automatically generated based on a date or the like. However, the customer may set the file name. It is also conceivable that the customer identifies the customized specifications with, for example, the file name of the dedicated file. However, it is difficult to identify the customized specifications with the file name when the customized specifications are complicated just like it is difficult to identify the customized specifications with the model number explained above.

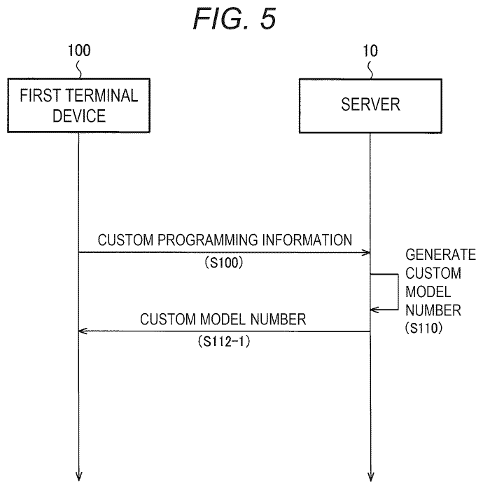

In the above example, the dedicated Web page is automatically opened when the writing program is activated. However, the dedicated Web page may not be automatically opened. For example, the custom programming information may be transmitted to the server 10 by attaching the dedicated file generated by the writing to an e-mail. The same applies to step S112-1 explained below with reference to FIG. 5. For example, the first terminal device 100 may perform processing for confirming that the first terminal device 100 and the server 10 are connected and may display a predetermined error indication when it is not successfully confirmed that the first terminal device 100 and the server 10 are connected. Alternatively, when the first terminal device 100 has not successfully transmitted the custom programming information to the server 10 when the customer has written the custom programming information in the evaluation sample using the writing device 110, the first terminal device 100 may perform processing for temporarily storing the custom programming information, which has not been successfully transmitted, and processing for retransmitting the stored custom programming information to the server 10 after a fixed time elapses.

As explained above, in the management method in the present embodiment, the management system 1 includes the writing device 110 that is connected to the first terminal device 100 and writes the custom programming information in the vibrator device 300. The server 10 receives, from the first terminal device 100, the custom programming information to be written to the vibrator device 300 by the writing device 110. Thus, the writing by the writing device 110 and the reception of the custom programming information from the first terminal device 100 can be associated.

The method in the present embodiment may be implemented as the custom product management system 1. That is, the custom product management system 1 in the present embodiment includes the server 10 and the first terminal device 100. The first terminal device 100 transmits the custom programming information written in the vibrator device 300 by the writing device 110 to the server 10. Thus, the same effects as explained above can be obtained.

As illustrated in FIG. 4, the vibrator device 300 may include the nonvolatile memory 310. The nonvolatile memory 310 is, for example, a one-time programmable read-only memory (PROM) but may be an electrically erasable programmable read-only memory (EEPROM) or a flash memory. That is, the writing device 110 includes an interface circuit for writing custom programming information in the nonvolatile memory 310.

Then, in step S100, the custom programming information may be written in the nonvolatile memory 310. Thereafter, the evaluation sample is removed from the socket of the writing device 110 and incorporated into equipment of the customer. The evaluation sample, which is incorporated in the equipment of the customer and is supplied with electric power again, develops set values in bits of registers based on the custom programming information written in the nonvolatile memory 310. Accordingly, after the electric power is supplied again, a clock signal having a desired frequency is output. The customizable vibrator device 300 and the writing device 110 may include an interface circuit for writing data in the nonvolatile memory 310 and may further include an interface circuit for directly writing setting values in the bits of the registers. This is because, for example, at the time of inspection in a manufacturing process for the customizable vibrator device 300, it is convenient to directly write the setting values in the bits of the registers because an inspection time is reduced.

As explained above, in the management method in the present embodiment, the vibrator device 300 includes the nonvolatile memory 310. The custom programming information is information written in the nonvolatile memory 310. Thus, every time electric power is supplied, custom specifications based on the written custom programming information can be reflected on the vibrator device 300.

The flow of the processing of the management method in the present embodiment may be as illustrated in FIG. 5. The flow of the processing illustrated in FIG. 5 is different from the flow of the processing illustrated in FIG. 2 in that the server 10 further performs step S112-1 after step S110. That is, in the management method in the present embodiment, the server 10 transmits the generated custom model number to the first terminal device 100 (step S112-1). Thus, the customer can acquire a custom model number corresponding to the created custom programming information. For example, the customer can confirm on the dedicated Web page that step S112-1 has been performed. That is, the customer may be able to confirm on the dedicated Web page relating to step S100 explained above that step S112-1 has been performed. Alternatively, after performing step S100, when a dedicated Web page is opened later, the customer may recognize that the custom model number has been acquired by performing step S112-1.

For example, in development on the customer side, a plurality of pieces of custom programming information have to be created. As explained above, creating a plurality of kinds of complicated custom programming information, and identifying the plurality of kinds of custom programming information impose a large load on customers. In this regard, by applying the method in the present embodiment, the customer can manage the custom programming information with the custom model number. Therefore, the management load on the customer can be reduced. For example, timing when the dedicated file explained above is created may be timing after step S112-1 is performed. The first terminal device 100 may create a dedicated file having a received custom model number as a file name.

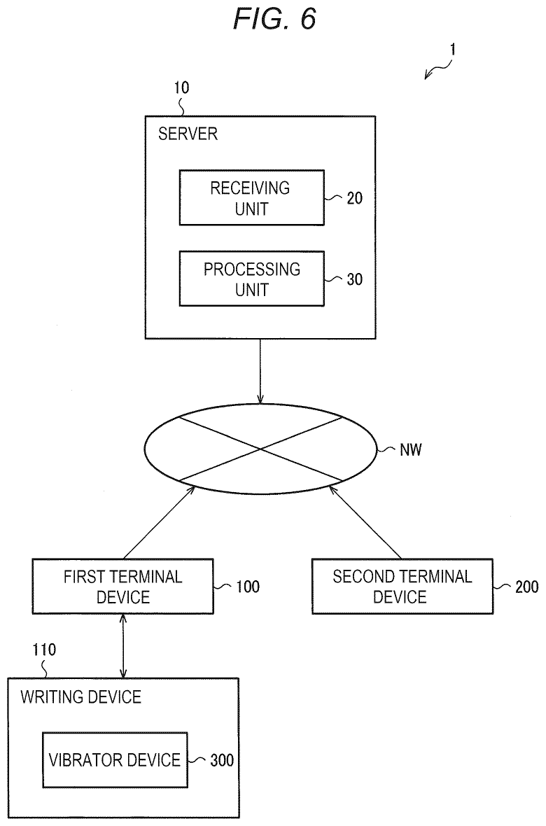

For example, when the customer is an prospective customer, in step $112-1, the server 10 may transmit information concerning the custom model number including information concerning a sales agency relating to a second terminal device 200 explained below with reference to FIG. 6. For example, when being requested to provide the evaluation sample and the writing device 110 from the prospective customer, the administrator or the like of the server 10 only has to correlate information indicating that the user of the first terminal device 100 is the prospective customer with information concerning the first terminal device 100 relating to the prospective customer.

The management system 1 in the present embodiment may have a configuration example illustrated in FIG. 6. The management system 1 illustrated in FIG. 6 is different from the management system 1 illustrated in FIG. 3 in that the management system 1 further includes the second terminal device 200. The second terminal device 200 is owned by a sales agency and managed by the sales agency. The second terminal device 200 is the same personal computer or the like as the first terminal device 100. That is, like the first terminal device 100 explained above, the second terminal device 200 includes a processor functioning as a processing unit and a communication interface functioning as a communication unit.

The sales agency refers to an institution that is entrusted with sales of commodities and performs a job of selling the commodities and is, for example, a semiconductor trading company. The sales agency may be a subsidiary of the manufacturer or may have no capital relationship with the manufacturer. The sales agency may be a special agent having a special contract with the manufacturer.

Although the management system 1 illustrated in FIG. 6 is illustrated as including one second terminal device 200. However, as explained above with reference to FIG. 1, the management system 1 may include a plurality of second terminal devices 200. That is, the management system 1 in the present embodiment can include the second terminal devices 200 as many as sales agencies.

Like the first terminal device 100, the second terminal device 200 may be able to activate the writing program and the dedicated Web browser explained above. The writing device 110 may be able to be connected to the second terminal device 200. In the writing device 110 connected to the second terminal device 200, a plurality of the sockets can be mounted on, for example, the circuit board explained above. Thus, the sales agency can mass-produce custom products of the vibrator device 300.

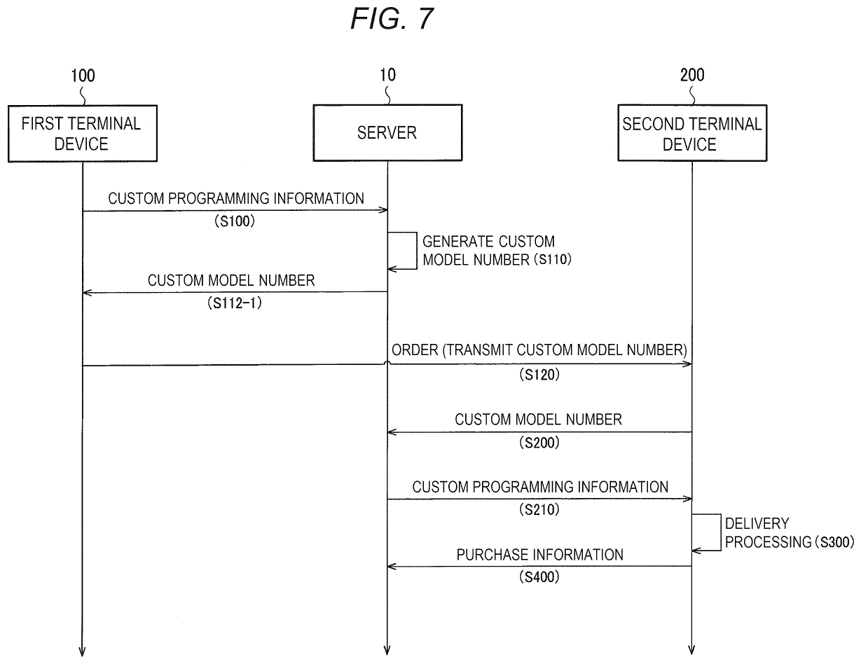

In the management system 1 illustrated in FIG. 6, the flow of the processing relating to the management method in the present embodiment may be as illustrated in FIG. 7. In the following explanation referring to FIG. 7, explanation is omitted as appropriate concerning the processing explained above.

In FIG. 7, as in FIG. 5, custom programming information is transmitted from the first terminal device 100 to the server 10 (step S100). The server 10 generates a custom model number (step S110). The server 10 transmits the custom model number to the first terminal device 100 (step S112-1). Thereafter, the first terminal device 100 places an order with the second terminal device 200 (step S120). Specifically, for example, at the time of development of equipment on the customer side, the customer creates plurality of pieces of custom programming information. The development of the equipment is completed, the specifications of the custom product of the vibrator device 300 are determined, and mass production of the equipment is started. Then, the customer extracts custom programming information based on the determined specifications among the custom programming information created in the past. Then, the customer transmits data of a custom model number corresponding to the extracted custom programming information to the second terminal device 200 via the first terminal device 100 using predetermined means. The predetermined means may be, for example, an e-mail, a telephone, or a facsimile.

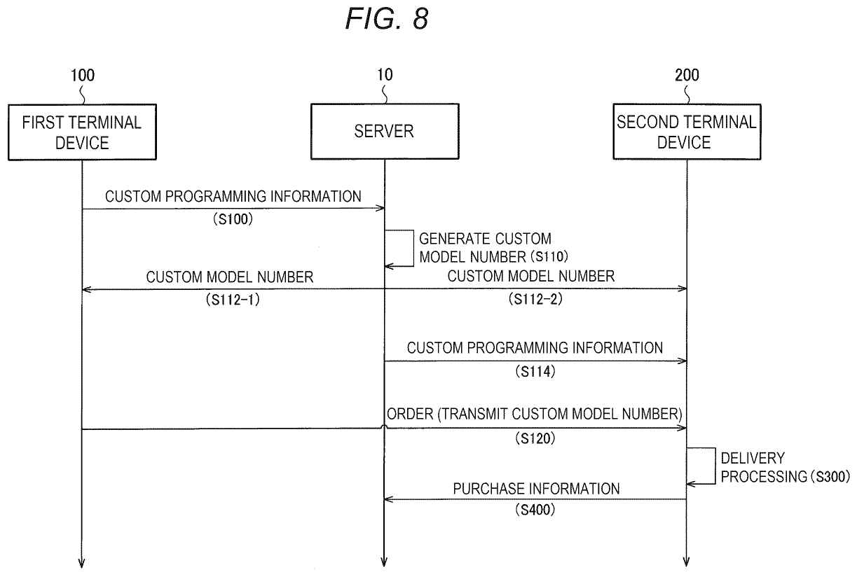

In FIG. 7, the transmission and reception of the data relating to the ordering (step S120) are illustrated as not being performed via the server 10. However, the transmission and reception of the data may be performed via the server 10. For example, the customer may place an order (step S120) using the dedicated Web page. That is, the data of the ordering (step S120) may be transmitted from the first terminal device 100 to the second terminal device 200 via the dedicated Web page. In this case, in FIG. 7, the transmission and reception of the data relating to the ordering (step S120) are performed via the server 10. The same applies to FIG. 8.

In step S120, besides the custom model number, the first terminal device 100 may transmit information such as a quantity, a delivery date, and a delivery place to the second terminal device 200. Alternatively, although not illustrated, in step S120, only the custom model number may be transmitted from the first terminal device 100 to the second terminal device 200, and the second terminal device 200 may perform processing for requesting information such as a quantity, a delivery date, and a delivery place from the first terminal device 100 at timing when delivery processing (step S300) explained below is performed. Alternatively, the person in charge of the sales agency may directly inquire the customer about the information such as the quantity, the delivery date, and the delivery place. As explained above, in the management method in the present embodiment, the management system 1 includes the second terminal device 200 connected to the server 10 and the first terminal device 100 via the network NW. By transmitting a custom model number notified in advance from the server to the second terminal device 200, the first terminal device 100 performs order processing for the vibrator device 300 having the custom model number (step S120). Thus, the customer can order custom products while easily distinguishing the specifications of the custom products to be ordered.

Thereafter, the second terminal device 200 transmits the custom model number to the server 10 (step S200). For example, the person in charge of the sales agency recognizes the reception of the custom model number relating to step S120 on a display unit or the like of the second terminal device 200 and operates the second terminal device 200 to transmit the information concerning the custom model number received in step S120 to the server 10. Alternatively, the information concerning the custom model number relating to the ordering in step S120 may be automatically transferred to the server 10. Alternatively, both the first terminal device 100 and the second terminal device 200 may include a writing program. Step S200 may be automatically performed after step S120 according to the writing program.

Thereafter, the server 10 transmits custom programming information correlated with the custom model number received in step S200 to the second terminal device 200 (step S210). For example, the processing unit 30 performs processing for extracting custom programming information correlated with the custom model number received in step S200 from the database and processing for transmitting the extracted custom programming information to the second terminal device 200.

As explained above, in the management method in the present embodiment, the management system 1 includes the second terminal device 200 connected to the server 10 and the first terminal device 100 via the network NW. When receiving, from the second terminal device 200, the custom model number ordered by the first terminal device 100 to the second terminal device 200 (step S200), the server 10 transmits custom programming information specified by the custom model number to the second terminal device 200 (step S210). Thus, the customer performs operation for transmitting the custom model number, whereby it is possible to construct the management system 1 that can order the custom product of the vibrator device 300. In other words, in the management method in the present embodiment, the management system 1 includes the second terminal device 200 connected to the server 10 and the first terminal device 100 via the network NW. When receiving the custom model number from the first terminal device 100 (step S120), the second terminal device 200 transmits the received custom model number to the server 10 (step S200) and receives custom programming information specified by the custom model number from the server 10 (step S210). Thus, the same effects as explained above can be obtained. The method explained above may be implemented as the custom product management system 1. That is, the custom product management system 1 in the present embodiment includes the server 10, the first terminal device 100, and the second terminal device 200 connected to the server 10 and the first terminal device 100 via the network NW. The second terminal device 200 transmits, to the server 10, the custom model number ordered by the first terminal device 100 to the second terminal device 200 (step S200). The server 10 transmits custom programming information specified by the received custom model number to the second terminal device 200 (step S210). Thus, the same effects as explained above can be obtained.

Thereafter, the second terminal device 200 performs delivery processing (step S300). For example, the sales agency performs work writing the custom programming information received in step S210 in the customizable vibrator device 300 for a quantity desired by the customer and delivers to a delivery place desired by the customer. For example, when the second terminal device 200 is connected to the writing device 110 adapted to mass production, the custom programming information only has to be written on the second terminal device 200 that has received the custom programming information in step S210. The delivery processing (step S300) ends when the person in charge of the sales agency receives a receipt relating to the delivery from the customer. For example, although not illustrated, the person in charge of the sales agency may use a predetermined mobile terminal and cause at not-illustrated storage unit of the second terminal device 200 to store information indicating that the receipt has been received or may regard it sufficient if a record of the receipt remains in the sales agency.

Then, at or after timing when the delivery processing (step S300) ends, the second terminal device 200 transmits purchase information to the server 10 (step S400). The purchase information is all information relating to the vibrator device 300 that has been purchased. Specifically, the purchase information is, for example, information concerning a model number of the vibrator device 300 relating to the purchase, information concerning a purchase quantity, information concerning a customer who purchased the vibrator device 300, information concerning a date and time of receipt, a place of receipt, and the like but, besides, may further include communication history information with the customer who purchased the vibrator device 300. The manufacturer may select, as appropriate, the information received by the server 10 in step S400 and cause a database to store the selected information. As explained above, in the management method in the present embodiment, the second terminal device 200 transmits the purchase information of the vibrator device 300 in which the custom programming information specified by the custom model number is written to the server (step S400). Thus, the manufacturer can automatically acquire the purchase information of the ordered vibrator device 300.

The flow of the processing of the management method in the present embodiment may be as illustrated in FIG. 8. In FIG. 8, explanation is omitted as appropriate concerning processing overlapping the content explained above. In FIG. 8, as in FIGS. 5 and 7, first, the first terminal device 100 transmits custom programming information to the server 10 (step S100) and the server 10 generates a custom model number (step S110).

Thereafter, the server 10 transmits the custom model number to the first terminal device 100 as explained above (step S112-1) and transmits the custom programming information received in step S100 and the custom model number generated in step S110 to the second terminal device 200 (steps S112-2 and S114). Step S114 in FIG. 8 is the same processing as step S210 in FIG. 7. That is, FIG. 8 is different from FIG. 7 in that, the manufacturer custom model number and the custom programming information are transmitted to the sales agent together, whereby the sales agent acquires the custom programming information in advance.

Thereafter, as in FIG. 7, the first terminal device 100 places an order with the second terminal device 200 (step S120). Then, the second terminal device 200 performs the delivery processing (step S300) and step S400 as in FIG. 7. As explained above, in the management method in the present embodiment, the management system 1 includes the second terminal device 200 connected to the server 10 via the network NW. When the custom model number is generated (step S110), the server 10 transmits the custom model number and custom programming information specified by the custom model number to the second terminal device 200 (steps S112-2 and S114). Thus, the sales agency can manufacture the custom product of the vibrator device 300 in advance. For example, before a formal order is placed, it is sometimes convenient to trial-manufacture the custom product of the vibrator device 300 relating to the order in advance and place the trial-manufactured custom product of the vibrator device 300 in a store.

As explained above, the present embodiment is a method of managing a custom product of a vibrator device in a management system including a server and a first terminal device of a customer connected to the server via a network. The server receives custom programming information to be written in the vibrator device from the first terminal device and generates a custom model number for specifying the received custom programming information.

Thus, the server can correlate the custom programming information with the custom model number. Accordingly, management of the custom programming information can be facilitated.

The management system may include a writing device that is connected to the first terminal device and writes the custom programming information in the vibrator device. The server may receive, from the first terminal device, the custom programming information that is written in the vibrator device by the writing device.

Thus, the writing by the writing device and the reception of the custom programming information from the first terminal device can be associated.

The server may transmit the generated custom model number to the first terminal device.

Thus, the customer can acquire a custom model number corresponding to the created custom programming information.

The management system may include a second terminal device connected to the server and the first terminal device via the network. When receiving, from the second terminal device, a custom model number ordered by the first terminal device to the second terminal device, the server may transmit custom programming information specified by the custom model number to the second terminal device.

Thus, it is possible to construct the management system that can order the custom product of the vibrator device by the customer performing operation for transmitting the custom model number.

The management system may include a second terminal device connected to the server and the first terminal device via the network. When receiving a custom model number from the first terminal device, the second terminal device may transmit the received custom model number to the server and receive custom programming information specified by the custom model number from the server.

Thus, it is possible to construct the management system that can order the custom product of the vibrator device by the customer performing operation for transmitting the custom model number.

The management system may include a second terminal device connected to the server via the network. When a custom model number is generated, the server may transmit the custom model number and custom programming information specified by the custom model number to the second terminal device.

Thus, the sales agency can manufacture the vibrator device of the custom product in advance.

The second terminal device may transmit, to the server, purchase information of the vibrator device in which the custom programming information specified by the custom model number is written.

Thus, the manufacturer can automatically acquire the purchase information of the ordered vibrator device.

The management include a second terminal device connected to the server and the first terminal device via the network. By transmitting, to the second terminal device, a custom model number notified in advance from the server, the first terminal device may perform ordering processing for a vibrator device having the custom model number.

Thus, the customer can order custom products while easily distinguishing the specifications of the custom products to be ordered.

The custom programming information may be information for setting characteristics of a signal output by the vibrator device by being written in the vibrator device.

Thus, the customer can acquire the vibrator device in which the characteristics of the signal are customized.

The vibrator device may include a nonvolatile memory. The custom programming information may be information written in the nonvolatile memory.

Thus, every time electric power is supplied, custom specifications based on the written custom programming information can be reflected on the vibrator device.

A server in the present embodiment includes a receiving unit connected to a first terminal device of a customer via a network and configured to receive, from the first terminal device, custom programming information to be written in a vibrator device and a processing unit configured to, when receiving the custom programming information, generate a custom model number for specifying the custom programming information.

A custom product management system in the present embodiment includes the server explained above and the first terminal device. The first terminal device transmits custom programming information written in the vibrator device by a writing device to the server.

The custom product management system in the present embodiment may include the server explained above, the first terminal device, and a second terminal device connected to the server and the first terminal device via a network. The second terminal device may transmit, to the server, a custom model number ordered by the first terminal device to the second terminal device. The server may transmit custom programming information specified by the received custom model number to the second terminal device.

Although the embodiment is explained in detail above, those skilled in the art could easily understand that many modifications are possible without substantially departing from the novel matters and the effects of the present disclosure. Therefore, all such modifications are included in the scope of the present disclosure. For example, a term described at least once together with a different term having a broader meaning or the same meaning in the specification or the drawings can be replaced with the different term at any place in the specification or the drawings. All combinations of the embodiment and the modifications are also included in the scope of the present disclosure. The components and the operations of the management method, the server, the custom product management system, and the like are not limited to those explained in the present embodiment, and various modifications are possible.

What is claimed is:

1. A management method for a custom product of a vibrator device in a management system including:
a server; and
a first terminal device of a customer connected to the server via a network,
the management method comprising the server:
receiving, from the first terminal device, custom programming information to be written in the vibrator device; and
generating a custom model number for specifying the received custom programming information.

2. The management method according to claim 1, wherein
the management system includes a writing device connected to the first terminal device and configured to write the custom programming information in the vibrator device, and
the server receives, from the first terminal device, the custom programming information written in the vibrator device by the writing device.

3. The management method according to claim 1, wherein the server transmits the generated custom model number to the first terminal device.

4. The management method according to claim 3, wherein
the management system includes a second terminal device connected to the server and the first terminal device via the network, and
when receiving, from the second terminal device, the custom model number ordered by the first terminal device to the second terminal device, the server transmits the custom programming information specified by the custom model number to the second terminal device.

5. The management method according to claim 3, wherein
the management system includes a second terminal device connected to the server and the first terminal device via the network, and
when receiving the custom model number from the first terminal device, the second terminal device transmits the received custom model number to the server and receives, from the server, the custom programming information specified by the custom model number.

6. The management method according to claim 1, wherein
the management system includes a second terminal device connected to the server via the network, and
when the custom model number is generated, the server transmits the custom model number and the custom programming information specified by the custom model number to the second terminal device.

7. The management method according to claim 5, wherein the second terminal device transmits, to the server, purchase information of the vibrator device in which the custom programming information specified by the custom model number is written.

8. The management method according to claim 1, wherein
the management system includes a second terminal device connected to the server and the first terminal device via the network, and
the first terminal device performs order processing for the vibrator device having the custom model number by transmitting the custom model number notified in advance from the server to the second terminal device.

9. The management method according to claim 1, wherein the custom programming information is information for setting characteristics of a signal output by the vibrator device by being written in the vibrator device.

10. The management method according to claim 1, wherein
the vibrator device includes a nonvolatile memory, and
the custom programming information is information written in the nonvolatile memory.

11. A server connected to a first terminal device of a customer via a network, the server comprising:
a receiving unit configured to receive, from the first terminal device, custom programming information to be written in a vibrator device; and
a processing unit configured to, when receiving the custom programming information, generate a custom model number for specifying the custom programming information.

12. A custom product management system, comprising:
the server according to claim 11; and
the first terminal device, wherein
the first terminal device transmits the custom programming information written in the vibrator device by a writing device to the server.

13. A custom product management system, comprising:
the server according to claim 11;
the first terminal device; and
a second terminal device connected to the server and the first terminal device via the network, wherein
the second terminal device transmits, to the server, the custom model number ordered by the first terminal device to the second terminal device, and
the server transmits the custom programming information specified by the received custom model number to the second terminal device.
